(19) United States
(12) Patent Application Publication
(10) Pub. No.: US 2003/0214060 A1
(43) Pub. Date: Nov. 20, 2003

(54) Method and apparatus for manufacturing plastic optical lenses molds and gaskets

(76) Inventor: Duane L. Wires, Ada, OH (US)

Correspondence Address: Benjamin A. Randall, 238 10th ST., Toledo, OH, 43624, US

(21) Appl. No.: 10/392,279

(22) Filed: Mar. 19, 2003

(30) Foreign Application Priority Data
May 7, 2002 (WO) PCT/US02/14434

(51) Int. Cl. B29D 11/00

(52) U.S. Cl. 264/2.5; 425/808; 264/1.37; 351/159; 425/174.4

(57) ABSTRACT

A method and apparatus for manufacturing plastic opthomalic and intra-ocular lenses and molds. The apparatus comprises a master mold for creating disposable or re-usable molds that may be used at point of sale. The molds comprise a “moth-eye” anti-reflective surface. The anti-reflective surface may be an integral part of the lens. The anti-reflective surface can be incorporated into a hardened surface of the lens. An improved curing chamber comprising reflective inner surfaces and directionally vector-less light is used for curing lenses. A gasket-less or reduced number of gaskets molding system are provided that may be either re-useable or disposable. An improved method of providing photosensitive eyeglasses and coatings.

### FIELD OF THE INVENTION

This invention relates to the molding of plastic optical lenses and in particular to the molding of plastic ophthalmic lenses.

### BACKGROUND OF THE INVENTION

In general, the art of molding plastic lenses involves the use of molds comprising a front half and a back half held together in a spaced apart relationship that forms an interior casting cavity. The interior cavity is filled with a liquid resin that is then hardened or cured to form a lens blank. Typically, the curing takes place through use of a catalyst or by raising the temperature of the resin or by exposing the resin to ultraviolet light. Both methods present problems when trying to cure lenses directly to prescription and with photo-chromatic dye in mass. Thermally curing lenses usually require organic peroxide initiators that are too toxic and dangerous to use in an office setting. Optical lenses cast to prescription using peroxide initiators tend to self-destruct during the curing process. The cast to prescription lens tends to crack or split into multiple pieces due to differences in shrinkage when there is a large differential between center and edge thickness. Photo-iniated monomers using ultraviolet light have a problems being cured due to poor penetration of UV light. This causes problems of pre-release of the thickest portion of the lens where there is a large difference between edge and center thickness. Minus powered lenses “thin in the middle and thick at the edges” tend to prerelease around the edge of the mold while plus powered lenses “thick in the middle and thin on the edge” tend to prerelease in the center. Pre-released lenses have optical distortions than reduce the optical quality of lens. Lenses cured with UV light tend to be cured more fully on surfaces closest to the light source.

Prior art has tried to deal with this problem by using very high intensity light sources that then require cooling systems to control the polymer reaction, or filters to vary the intensity of the curing light to be greater in the thicker portion of the lens while reducing the intensity of the light in the thinner areas. This system tends to lead to decreased yields due to operator error, if the operator forgets to install the filter, or installs the improper filter.

Another problem with curing with Ultraviolet light is that of trying to cure a monomer containing photo-chromatic dyes. Photo-chromic dyes absorb UV light and change color, further reducing light penetration. UV dyes absorb the UV light and reduce or prevent curing. Infrared dyes tend to absorb UV light in addition to Infrared light. This problem has been addressed in the past by curing the lens from both sides and by using wavelength selective filters. Wavelength selective filters reduce the rate of curing and limit the amount of photo-chromatic dye that can be added to the monomer. A preferred technique of the new invention is to cure with a wavelength of light that is not absorbed by photo-chromic, UV, and Infrared Dyes.

Curing from both sides with transparent molds increases the potential of lens failure from leaking monomer or fingerprints on the non-curing surface causing a shadow effect. Shadow effect causes visible optical defects in the final cast lens. Curing with visible light with a wavelength peak above 400 nm can eliminate the above problems caused by poorer penetration of UV light. One light source with a 400-nm+ range is a florescent bulb having a peak spectral output of approximately 470 nm light source is the ELC 500 from Electro Lite Corporation. This Light source combined with a photo-initator Irgacure 819 by CIBA Specialty Chemicals, which is very reactive above 400 nm, can produce visible-light cured lenses. Another potential initiator is Lucernine TPO by BASF Corporation. Other potential light sources could be Halogen or Xenon light. Visible light curing above 400 nm also makes curing photo-chromic lenses easier to cure because the lenses do not change color during the curing process, and thus do not interfere with the light's ability to penetrate the lens. A disadvantage to this process is the high color of the initiator. Initiators that have a visible component tend to impart a yellow or orange color to the final cast lens. This color may be bleached from the cast lens by exposing the final product to UV light either while still in the mold assembly or after disassembly. Additional surface hardness or curing of the lens may be achieved by the addition of a short wavelength UV only initiator, such as Irgacure 184 or Irgacure 500. These photo-initiators do not have a visible component and are near colorless when dissolved into the monomer and may be used in higher concentrations than traditional initiators. A small amount of complimenting dye or optical brightener may be added to the monomer to counteract the yellow color.

Secondary exposure of the lens to short wavelength UV light below 400 nm may occur as follows. The lens may or may not be separated from the mold assembly and may photochrome, or change color, during this process. Color change of a photochromic lens is not of concern, as surface curing is the only concern. This secondary step may increase scratch resistance by increasing surface cross-linking. One problem with crosslink in any monomer is decreased impact resistance because cross-linking increases the brittleness of the cast lens. Surface cross-linking allows for the lens center to be softer than the surface and thus increasing impact resistance. Tintability of a lens with increased cross-linking is improved by having a less porous surface. Antireflective coating may be also improved by having a more fully cured surface.

One known polymer is a polyethylene glycol diallylcarbonate with the addition of a catalyst, for example, isopropyl percarbonate, sold under the trade name CR39. However, this polymer and similar polymers have undesirable shrinkage during the curing process. Shrinkage tends to pull the lens away from the mold halves, allowing air to enter the mold, destroying the lens. An additional drawback to the CR39 type of resins is the lengthy cure time, sometimes as long as 17 hours. The types of resins used, the different types of apparatus used to construct the molds are those such as described in application Ser. No. 09/741,780, the disclosure of which is hereby incorporated by reference.

Mold halves are typically made of a hard material such as glass or metal whose inner surfaces provide a desired shape to the lens. When removed from the mold, the lenses are shaped to fit a particular frame. In general, it is necessary to have a separate mold for each prescription. It is desirous to have a molding apparatus and method that provides a lens with a finished surface, thereby avoiding secondary finishing operations like grinding and polishing. The molding systems currently known in the art have two major drawbacks. The molds must be manufactured to exacting dimensional tolerances, include or be constructed from an inflexible and hard material such as metal or glass, and must be cleaned prior to each use. Additionally, the surface of the mold halves forming the lens surfaces often must have a polished finish. Any imperfection in the surface of the mold halves, or any foreign material such as dust or fingerprints present on the mold halves during the molding process will result in imperfection in the lens. In some apparatuses, one of the mold halves will be made of a hard substance with a reflective surface. Such a prior art system utilizing a back mold with these properties is described in application Ser. No. 09/741,780. The high degree of cleanliness, surface finish, and manufacturing tolerance makes these molds expensive to produce. Additionally, the mold halves can be damaged during the cleaning process. Specifically, producing a lens with a surface micro- structure for anti-reflective properties requires a mold with an attached or transferred microstructure on its surface. Such microstructures are easily damaged during cleaning.

The use of a liquid resin in the mold forming process necessitates that a gasket or dam that prevents the resin from escaping from between the halves surround the front and back halves of the mold. In molding techniques where a gasket is used to hold the mold halves in alignment and the resin is cured using ultraviolet light, the gasket tends to block light transmission causing “shadows” or imperfect curing of the lens. Similarly, any device used to hold the mold halves in position that is not transparent to light can cause imperfections during the curing process.

In techniques where heat is used to cure the resin, the gasket tends to become deformed, allowing the resin to leak from the mold or causing misalignment of the mold halves, creating deformities in the finished lens. These types of systems and their associated problems are described in application Ser. No. 09/741,780.

The gaskets used in prior art systems hold the mold halves in an orientation to each other that defines the thickness of the lens. The lens may be formed such that there is a difference in thickness over the body of the lens, to accommodate aspheric designs. Such systems are also used for creating prescription bifocal and progressive lenses.

Generally, orientation of the mold in the curing chamber is critical to successful formation of a non-deformed lens. The majority of prescriptions require that one side of the lens be concave and the other side of the lens be convex. It is generally impossible to fill mold with resin such that there is no residual air. If the mold is oriented such it that the convex side is facing upward, the air remaining in the mold will tend to migrate to the center of the lens creating a bubble in the finished product. This generally ruins the lens. This drawback is present whether heat or light is used to cure the resin.

Molding systems using ultraviolet light to cure the resin previously described in the art often use a front mold that is non-transparent to light. Such molds are typically made of metal and may be plated to provide a reflective and polished surface that transmits light back into the resin, thereby improving the curing process. These types of molds are expensive to manufacture, especially where they incorporate bifocal or progressive lens formations, and are typically used repeatedly by a lens-making practitioner. The back mold is typically made of glass, or other hard, UV-light transparent material. The back molds in these systems are concave, and a gasket and mold assembly is typically placed in the curing chamber in a horizontal orientation such that the back mold faces upward. Any residual air trapped in the mold thereby tends to migrate to the edges of the mold. Any imperfections in the edges of the molds are removed during the shaping process. Systems using a non-transparent back mold cannot use a horizontal orientation. These types of mold assemblies must be placed in the curing chamber in a vertical orientation.

Molding systems using UV-light to cure the resin generally have a single light source that is used in conjunction with a diffuser to establish a field of randomly oriented light. The placement of the light source in part determines the orientation of the mold assembly in the curing chamber, and the materials from which the mold assembly may be made. It is generally desired to have the mold elements transparent to UV or visible light, with the exception of the front mold halve. A light source placed at the top of the chamber necessitates a mold assembly with a light transparent back mold placed in a horizontal position with the transparent back mold facing the light source and the reflective or non-transparent mold on the opposite side. Prior art systems have also used reflective front molds to held alleviate defects formed in the lens by refraction and reflection off the surface of the front mold. Such mold assemblies are described in application Ser. No. 09/741,780. A single light source presents a light field with a directional orientation that remains partially intact, even after passing through a diffuser. The light field directional vector is an important factor in imperfect curing of the resin due to refraction, diffraction and cancellation of the light as it passes through the lens mold assembly and the resin. The different light transmission and refractive indices of the lens mold material tend to create “shadows” or imperfectly cured areas in the finished lens. Typically, lens molds are rotated within the light field to more homogenize and randomize the exposure of the resin to the UV-light.

The methods used in prior art systems preparing lenses for curing involves setting up the mold assembly, filling the resultant casting cavity with resin, curing the resin, and then removing the finished lens. Generally, filling the casting cavity involves transferring resin from a holding reservoir to the casting cavity. In one such system in the prior art, the desired resin formulation is transferred from a bulk container to a pressurized canister such as the type used in painting operations. The canister is generally pressurized with compressed air, and forced from the canister to a hose or tube to a delivery device such as a wand with a hollow tip, the tip being sized so as to fit into the casting cavity. The resin typically must be filtered during the transfer process to prevent contaminants being present in the finished lens. This system requires that the operator maintain a bulk supply of resin on hand, along with the appropriate equipment for transferring the resin, filtering the resin during the transfer process, maintaining the equipment to supply compressed air or other gas, and ensuring the air or gas supply does not introduce contaminants into the resin.

The type and formulation of the resin used may differ between lenses. As an example, if a lens is desired that is clear, one resin formulation will be used. If a finished lens is desired that has photo-chromatic properties, the ability to change color or tint upon exposure to particular ranges of wavelengths of light, a different resin formulation is used. The same is true for finished lenses that have a particular stable coloration. Most practitioners will have neither the ability nor the desire to mix their own formulations and if they did, they would have to have on hand a supply of the desired resin formula. The ability of the operator to meet customer demand for various types of lenses requires a significant investment in bulk material inventory and storage. Deriving formulations from bulk quantities of resin also places upon the operator the burden of accurately measuring and dispensing to a delivery device an amount of resin sufficient to cast a desired number of lenses, and adding the correct dyes and photo-initiators to the formulation. Creating a formulation for casting either a very small number of lenses, or erring in the amount necessary for a larger amount can lead to waste and additional expense. Additionally, using the prior art systems, the canister and related hoses, tubing and delivery wand must be thoroughly cleaned between uses. All of these conditions add expense and time to the process.

The apparatus and methods disclosed herein are also applicable to the manufacture of optical lenses and inter-ocular lenses having anti-reflective properties. The current art of manufacturing optical lenses with anti-reflective properties involves using pre-manufactured lenses and coating them with at least seven micro thin layers of metallic coatings after the lens is finished. The light passes through the successive layers and is prevented from being reflected back toward the source. This method has the disadvantage of requiring application of the anti-reflective coating after the lens is manufactured. Additionally, the anti-reflective coatings known in the art have a tendency to peel off of the lens, or to become damaged by scratching.

Inter-ocular lenses are lenses surgically inserted in the eye and are commonly used for patients after cataract removal surgery. The major complaint of patients having these lenses installed in their eyes is glare. Incorporating an anti-reflective microstructure into the surface of inter-ocular lenses would eliminate glare. The present invention anticipates an improved method of forming anti-reflective microstructures on inter-ocular as well as external lenses. Use of two intersecting light beams to form interference patterns on a master mold coated with a photo-resistive material is used in one embodiment of the present invention. Use of a third intersecting light beam has been shown to improve the shape of the micro-structure to eliminate glare or interference fringes generated by the micro-structures and has been shown to improve the stability of the micro-structures and to help eliminate damage due to cleaning. These microstructures now can be achieved through the use of precision three to five axis laths. A lath can cut the micro pattern on the optical surface by cutting the micro groves. It is assumed there may be other methods to create the pattern that has not been disclosed in this application that do not negate the concept of the art.

There is therefore a need to provide a lens casting system that may be used by a practitioner or operator that addresses these identified problems.

The present invention is directed toward methods and apparatus that allow a practitioner in the lens making business to prepare lenses for eyeglasses quickly and inexpensively. Specifically, the present invention is directed toward a method using an improved curing chamber that essentially provides a randomized, directionally vector-less light field, eliminating the requirement for a particular mold orientation.

The present invention is also directed toward a method using an improved curing chamber that utilizes visible light.

The present invention is also directed toward a method using a post curing UV box that directs UV light towards the assembled or unassembled lens

The present invention is also directed toward a method using an improved curing chamber that may or may not have two light sources, one visible and one UV that are controlled by a controller that will cure the lens first with visible light and then surface hard the lens using UV light.

The present invention is also directed toward a method of making a improved lens by first curing the lens with visible light, then post curing the surface using UV light.

The present invention is also directed toward a method using an improved curing chamber with a controller that authorizes the use of the chamber, through the use of a swipe card or a computer chip key. The authorization code allows the unit to run for a predetermined number of cycles before reauthorization is required.

The present invention is also directed toward a method and apparatus for forming a lens mold that eliminates the need for gasket or a new gasket that reduces the number of gaskets required to make all possible prescriptions.

The present invention is also directed toward a method and apparatus that eliminates the need for cleaning at least one of the lens molds by providing a disposable, inexpensive front or back mold. The present invention is also directed toward providing a method and apparatus that provides a reusable mold that is easily cleaned and is not easily damaged during the cleaning process.

The present invention is also directed toward a method and apparatus that eliminates the need for the practitioner to maintain bulk quantities of resin formulations by providing a pre-mixed, pre-filtered, pre-measured amount of a specific resin formulation in a disposable container.

The present invention is also directed toward a method and apparatus that eliminates the need for a practitioner to transfer resin to a pressurizable container for delivery to the mold.

The present invention is also directed toward methods, apparatuses and compositions for making polymer-based molds that can impart anti-reflective properties to the lenses cast from the polymer based molds. The present invention provides a new design of mold that creates a micropattern on the surface of the cast lens. The micropattern will not peel or scratch off because the micropattern is part of the composition of the lens itself.

The present invention is also directed to methods of manufacturing polymer-based molds that may be used to impart anti-reflective properties to the lenses that are cast from the molds. The mold can be used on a disposable or frequent replacement basis.

The present invention is also directed to methods of manufacturing polymer-based gaskets that reduce the number required to cover all prescription ranges. Insert can be used on a disposable or frequent replacement basis.

The present invention is also directed to methods of manufacturing polymer-based gasket inserts that may or may not have a filling port to aid in dispensing monomer into the mold cavity. The insert can be used on a disposable or frequent replacement basis.

The present invention is also directed to methods of manufacturing polymer-based insert that has varying heights that match the contours of the back mold. The insert can be used on a disposable or frequent replacement basis

### SUMMARY OF THE INVENTION

The present invention provides methods and apparatuses for making plastic optical lenses and in particular for optical lenses for eyeglasses. The present invention also provides a method for manufacturing molds that are useful to produce lenses with anti-reflective properties.

The present invention is useful in casting prescription spheric and aspheric single vision, bifocal and progressive lenses. The present invention can be practiced by the user in an office setting, reducing costs and preparation time of the lenses. The present invention also significantly reduces the capital investment a practitioner would have to make over prior art systems.

One of the methods of the present invention allows the user to produce thinner lenses with anti-reflective properties by providing molds with microstructures imparted onto the mold surface. In addition the use of visible light instead of UV light increases yields and allows for the casting of lenses with photochromatic, UV and or Infrared blocking a dyes without the need of any additional filters, heating or annealing. No cooling systems, pulsating exposures, or heat annealing ovens are required in this process. The use of 80 mm front molds with smaller optical zones 65 mm or less allows for the casting of thinner plus power lenses than current art methods where optical zones are closer to the mold diameter.

The apparatus and method of the present invention provide a lens making practitioner with a system provided by a single supplier that includes the equipment necessary to cast and cure prescription eyeglass lenses. The present invention anticipates that a practitioner will obtain a system from the supplier that includes the desired resin formulations in pre-packaged containers, the apparatus for dispensing said resins, the front and back molds used to create the lenses, the curing chamber, and also provides premixed and pre-measured formulations of resin.

In a preferred embodiment, the resin is contained in a pre-packaged container that the practitioner orders from the supplier. In a preferred embodiment, the container is a flexible plastic bag, such as an IV bag, but where the material forming the bag is impervious to light so as to protect the resin from premature curing. The apparatus of the present invention includes a delivery device that holds and provides a means for dispensing the resin. In a preferred embodiment, the delivery device consists of a flexible envelope that surrounds the resin bag. The envelope comprises an inflatable bladder that expands to exert pressure on the resin bag. The resin bag comprises an opening or port that a dispensing hose and wand are attached to.

The method of the present invention anticipates the practitioner pressurizing the bladder as needed to force resin from the bag, through the dispensing wand and into the mold cavity. In a preferred embodiment, the bladder is pressurized using a hand actuated pump such as commonly found on blood pressure cuffs, as are well known in the art.

The present invention further anticipates the use of a reduced gasket or gasket-less lens mold system and a mold system that uses a reduced number of gaskets. In systems used in the prior art, a separate gasket that defines the orientation and spacing of the front and back molds is necessary for each prescription. Consequently, a lens-making practitioner must keep a large number of gaskets on hand. The practitioner must allocate a large amount of storage area and expense for the gaskets. Gaskets can also be easily damaged by overheating and eventually become stretched and misshapen by continued use. A system that reduced the necessary number of gaskets, or completely eliminated the need for gaskets would allow a practitioner to make lenses less expensively and more efficiently.

The present invention provides a method of manufacturing polymer-based molds for making optical lenses for eyeglasses. In another aspect, the present invention provides a method for manufacturing molds that are useful to produce lenses with anti-reflective properties. These methods are applicable to both the manufacture of lenses for eyeglasses and for inter-ocular lenses.

The present invention is useful in casting prescription spheric and aspheric single vision, bifocal and progressive lenses. The present invention is also useful in casting photo-chromatic lenses that can be made in a multitude of shades and colors and lenses with Visible UV or Infrared dyes mixed in mass in the monomer.

The method of the present invention allow the use to produce thinner lenses with anti-reflective properties since lenses made using the polymer based molds have micro-structures cast onto the mold's surface. According to the method of the present invention for making plastic lenses, a UV and or Visible light sensitive polymerizable lens forming material is dispensed into a polymer based mold cavity. In embodiments where an anti-reflective lens is desired at least one suitable mold surface has microstructures formed on the surface of the mold.

The polymer-based mold is manufactured using an injection molding of a thermoset plastic material. In certain embodiments, the thermoplastic material used to make the polymer-based mold may transmit light to allow for curing. In another aspect, the polymer-based mold may have a metallic coating or at least one surface that reflects light to assist in single light source curing. In still another aspect, the polymer-based mold may be opaque and may not transmit light at all for use in single light source curing or for heat based curing.

Manufacturing of the injection molds includes forming a negative insert in a master mold of the mold design and curves. Inserts can be made of glass, metal, or electroform, traditionally most inserts are backed electroforms. The master mold can be made of glass, stainless steel, or formed by electroforming nickel. The electroformed inserts are copies of glass, nickel, or stainless molds.

Molds that are to be used to produce anti-reflective lenses have a photo-resist material applied to a master mold. The photo-resist material is been exposed to at least two beams of laser light that intersect at high angles. The high angle beams of light produce interference patterns on the photo-resist material. The light exposure to the photo-resist material causes a chemical reaction in the exposed photo-resist material while no reaction in the unexposed material. After an appropriate exposure time, the photo-resist mold master mold is rotated 90 degrees and re-exposed, creating a checkerboard pattern of exposed in unexposed photo-resist material on the mold. The photo-resist material is then developed in a suitable manner and optionally may be hardened. The hardening of the master mold improves the ability to make copies from the master mold. The photo-resist coated/developed master mold is then copied, preferably through a process of electroforming to form an electroformed insert. A new technique of using a 3 to 5 axis lath has been developed that can cut the fine patterns to produce the motheye into stainless, and or stainless that has nickel deposited on to it. The electroformed or lathe cut insert is then placed into the injection-molding cavity and used to make the polymer-based mold. The polymer-based molds can be manufactured for both the front and back optical surface of the lens. Polymer molds may have a coating placed on them to increase their chemical resistance and extend the useful life of the mold. They also may have a transferable hard coating or hydrophobic coating placed into the mold prior to lens casting, either onsite by the operator or by the manufacturer of the mold.

The method for imposing the anti-reflective pattern using photo-resist materials and lasers may be improved by using more than two intersecting laser beams. Use of a third laser allows the interference pattern to form interference patterns that have a square profile in depth and circular in cross section. The resultant pattern imposed upon the photo-resist material that becomes part of the lens or the mold is then perfectly circular and does not create interference fringes or glare. The improved shape of the microstructure also helps to prevent damage to the microstructure due to cleaning of the lens.

In an embodiment of the present invention, the front mold may or may not have a reflective inner surface to reflect visible and or UV and visible light after the visible and or UV and visible light passes through the polymerizable lens forming material. If the inner surface of the front mold is reflective it will allow more light energy to be directed to the lens forming material that, in turn allows the material to cure more quickly. The reflective inner surface of the front mold illuminates the entire resin material, thereby eliminating any shadow problems that occur in the prior art lens casting processes. In the prior art lens casting processes where front and back transparent molds are used, shadows may be created. In the prior art lens casting processes, the shadows or defects in the polymer are due to the refraction of the UV light as passes through a first transparent mold, the polymer material and then the second transparent mold.

In one embodiment of the present invention, the visible and or UV and visible light is diffused before contacts the polymerizing lens forming material. The diffuse to visible and or UV and visible light provides a uniform intensity of light exposure to the polymerizable lens forming material. In preferred embodiments, the mold members are rotated during exposure to the diffuse visible and or UV and visible light to further the uniformity of light energy and exposure of the polymerizable lens forming material to the visible and or UV and visible light.

In one embodiment, the front mold comprises a material such as glass were mirrored coated material, nickel or stainless steel material which may be coated with a hard scratch resistant material. In certain embodiments, a nickel mold is electroplated with a chromium, rhodium, or carbon surface that produces a hard surface on the mold. A hard smooth surface of the front mold allows the cast lens to be readily removed after lens is cured.

In embodiments of the present invention that incorporate the use of a new design of gasket that reduces the current number of gaskets used in the system from 95 to less than 30. The new gasket designs are made of a transparent polymer based electrometric material that holds its shape during the curing process. The gasket is transparent to visible and UV light. The gasket does not change shape or form when exposed to the heat generated during the curing reaction. The new gasket design has a first, lower annularly expanding lid or edge that extends circumferentially around inner surface of the gasket. This annular ring has varying thickness to correspond the thinnest edge thickness of the final cast lens. A secondary disposable insert that has a varying thickness is inserted into the gasket this ring has a varying thickness that corresponds the varying edge thickness of various lens powers where the radius of curvature of the back mold varies. The gasket may have a notch that locks the insert into place preventing it from turning during mold insertion. The gasket may have an overflow vent that prevents the molds being separated by hydrostatic pressure of the monomer during filling. The overflow vent directs excess monomer away from the molds, to prevent monomer form leaking over the casting surface. The gasket may have a secondary fanned insert that fits into a side cavity to aid in filling the space to be occupied by the lens. The gasket also may have a second, upper annularly expanding lid or edge having a predetermined height. The upper edge extends circumferentially around inner surface of the gasket. The height or thickness of the upper edge will vary from gasket to gasket, depending on the desired thickness of the lens. The back mold member is positioned in the gasket such that a lower surface of the back mold member of rests on the upper edge of the disposable insert. When the front mold member is placed in abutting relationship to the lower edge, the gasket seals around the entire circumference of the front mold member. The upper edge of the gasket holds the back mold member in a spaced apart relationship from the front mold member. The back mold member and the front mold member define a space or casting cavity that receives the UV polymerizable lens forming material.

The lens casting assembly which comprises the front mold, the gasket, and the back mold, is held in a steady position so that the polymerizable lens forming material can be dispensed in the space or cavity find between the front mold member and the back mold member through a angled channel that allows the monomer to enter the cavity with out having to distort the gasket. Another method if filling nay be through a fanned channel that may be sealed by a secondary insert.

In a preferred embodiment, a secondary insert matchs the fan in shape and seals against the gasket and mold, allowing the monomer to be forced into the space through a wider area at a reduced pressure. This reduced pressure reduces the chance of the molds being floated off the gasket seat during the filling process. If the molds are floated off the gasket seat the resulting cast lens may be too thick and may have induced prism as a result of the molds no longer being parallel to each other. The polymerizable lens forming material does not leak from the casting cavity due to the presence of the lower, self-sealing edge of the gasket. This self-sealing edge may be comprised of one or more raised rings that aid in sealing the lower mold.

The appropriate front mold, back mold, and gasket are assembled and a suitable monomer based material is placed in the cavity. The polymerizable lens forming material is exposed to diffuse ultraviolet light for short period of time, about 2 to 4 minutes. Preferably the polymerizable lens forming material is exposed to ultraviolet light for about three minutes. There is no need to add thermal energy to the casting process. Further, there is no need to cool or remove thermal energy from the polymerizable lens forming material after lens is been cured with visible and or UV and visible light.

The present invention is useful with a polymerizable lens forming material that comprises a rapidly curing mixture of a resin material that cures upon exposure to visible light and at least one photo-initiator that absorbs both ultraviolet light and visible light. In one embodiment, the photo-chromatic lens forming material comprises a mixture of the polymerizable lens forming material and at least one photo-chromatic dye. Suitable photo-chromatic dyes remain stable when exposed to ultraviolet light the photo-chromatic compositions comprise at least one photochemical substance that has an induced reversible color change when exposed to different wavelengths of light, such as sunlight or ultraviolet radiation. When the light sources removed, a photochemical substance reverts back to the original color. The cycle times for color change differ depending on medium in which the photochemical substance is dispensed.

The present invention includes the use of a curing chamber which provides an essentially directionally vector-less light field which is also homogenous in intensity. The curing chamber may have an interior that comprises mirrored surfaces that are positioned at angles that enhance the homogenization of intensity and diffusion of the light, and comprises a plurality of light sources. The curing chamber also includes a rotating turntable, preferably constructed from a UV transparent material. The present includes the use of a curing chamber with a controller that authorizes the use of the chamber, through the use of a swipe card or a computer chip key. The authorization code allows the unit to run for a predetermined number of cycles before reauthorization is required.

The current art in providing anti-reflective and scratch resistant properties to lenses involves coating the finished lens in a secondary operation. The apparatus and methods herein provide a formulation for polymer-based lenses that result in a scratch resistant coating that is not applied in a secondary operation. The present invention provides a flourinated methacrylate that when cured, has a hard, scratch resistant outer surface. This, in combination with an imposed microstructure in the surface of the finished lens makes the lens provides a scratch and peel resistant anti-reflective surface. In applications where an anti-reflective surface is not desired, the process may be used without an imposed microstructure mold.

Another improvement over the prior art in providing scratch resistant and anti-reflective properties to lenses is provided by the methods herein. The current art applies scratch resistant and anti-reflective coatings to lenses after they are finished. A method of the present invention provides for applying a chemical film to the surface of the mold prior to introduction of the polymer and curing. These chemicals are commonly known as “hard-coat” or “sol-gel and/or hydrophobic coatings during the curing cycle of the lens the film becomes bonded to the polymer substrate. Used in conjunction with a mold that imparts an anti-reflective microstructure to the surface of the lens, a hard, scratch resistant, anti-reflective outer layer is formed on the outer surface of the lens that is not susceptible to peeling.

During the formation of the lens it may also be necessary to produce a lens that has infrared absorption. Infrared dyes are hard to imbibe into a finished lens because they tend to be non-water soluble. When added through the use of solvents the imparting lens tend to be damaged by the solvent carrier. Additionally the dye only infuses into the lens a few microns from the surface, thus making it easy to leach our through general use and cleaning. Having a lens with the Infrared dye dispersed throughout the monomer has many advantages if it can be cured. Most infrared dyes absorb heavily in the UV and infrared, with a window of light transmission in the visible. Thus, using visible light or heat is the preferred method of curing.

The present invention uses visible light having a peak spectral output at 470 nm and a photoinitiator that has a visible component such as Irgacure 819 or Lucerine TPO. The surface of the lens may be further hardened or cured by a secondary exposure while still assembled or after disassembly by surface curing with short wavelength UV light. This light source may be through the use of secondary UV light installed in the same curing chamber and through the use of a controller that turn the UV source on after the lens is initially cured with visible light. The UV light source may be provided through a simple curing box that the mold assembly is placed in after the initial cure of after disassembly. An additional initiator may be added to the monomer on such as Irgacure 184 or Irgacure 500 that has no visible component but will aid in surface curing when exposed to UV light. The use of this system may also be aided thought the use of exposure ambient sunlight. Lenses may be cured with or with out the use of a diffuser and ambient sunlight.

### DESCRIPTION OF THE DRAWINGS

FIG. 1 is a perspective view of the curing chamber of the present invention.

FIG. 2 is a perspective view of a flexible bag containing a resin formulation.

FIG. 3 is a perspective view of the inflatable envelope used to force the resin formulation from the flexible bag.

FIG. 4 is a perspective view of the inflatable envelope with the flexible bag inserted and connected to the delivery tube and dispensing wand.

FIG. 5 is a cut-away view of mold assembly.

FIG. 6 is a detailed view of the annular dam.

FIG. 7is a perspective view, partially broken away, of an apparatus for producing a plastic lens.

FIG. 8 is another perspective view of an apparatus for producing a plastic lens.

FIG. 9 is a perspective view of a lens casting mold component of the apparatus of the present invention.

FIG. 10 is a cross-sectional view of a lens casting mold component for use in the apparatus of the present invention.

FIG. 11 is a perspective view of a resin dispensing apparatus and the lens casting mold component.

FIG. 12 is a cross-sectional view of a lens casting mold component being filled with a UV light curing polymer material while being held in the resin dispensing apparatus.

FIG. 13 is a schematic illustration of a method for making a polymer-based mold that has an interior surface capable of imparting an anti-reflective surface to an optical lens.

### DESCRIPTION OF THE PREFERRED EMBODIMENT

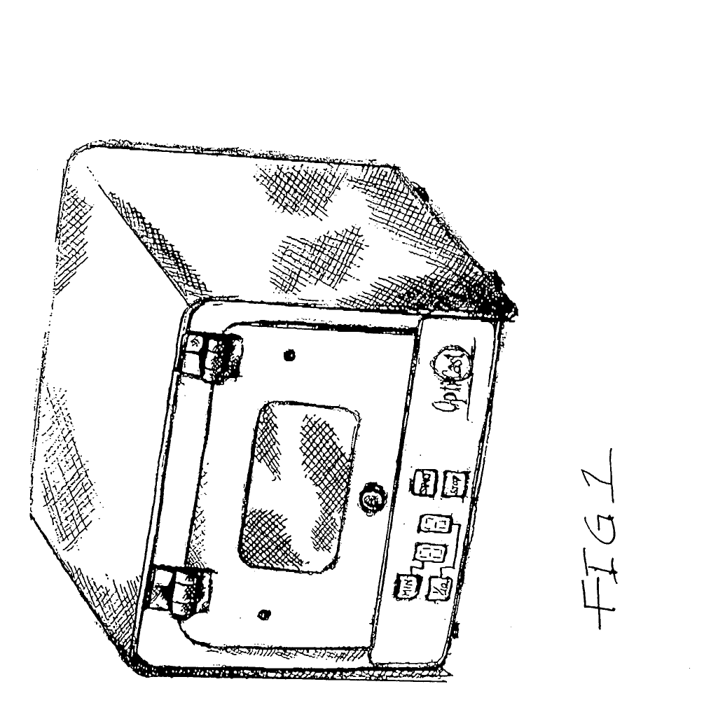

Referring to FIG. 1, the curing chamber of the present invention is shown generally at 10. The curing chamber comprises a plurality of light sources 11, mirrored interior surfaces 12, and a turntable 13. The light sources are placed at locations within the chamber 10 such that the sources are essentially equidistant from the turntable 13. The equidistant placement of the light sources 11 ensures that no single source appears at a greater intensity than the other sources from the top surface of the turntable 13. The mirrored surfaces 12 are placed behind the light sources 11 and on all interior surfaces of the chamber 10 except for a central portion of the door of the chamber 14. The door 14 comprises a view port 15 that allows an operator to view the process and interrupt the process if something goes wrong. In a preferred embodiment, the view port is a tinted panel that blocks UV light so as to protect the operator's eyes. The turntable 13 is generally sized to accommodate the item to be cured. In a preferred embodiment, the turntable 13 is approximately 3 inches in diameter, so as to accommodate a lens mold and is UV light transparent, to allow light transmission to the lower parts of the item to be cured. It is anticipated that different sized chambers and turntable may be used. In the preferred embodiment, a single lens is cured at a time, but it is anticipated that the present invention may be utilized to cure a plurality of lenses at once, by providing appropriately sized equipment. In an embodiment of the present invention where the surface of the mold in contact with the turntable 13 is desired to be UV and visible light transparent, the turntable 13 will be constructed from a UV and visible light transparent material that closely matches the refractive index of the mold material, to minimize refractive and reflective phenomena.

The light sources 11 in the preferred embodiment are visible light producing fluorescent tubes with a peak spectral out put around 470 nm, such as are commonly known in the art. The mirrored surfaces 12 of the curing chamber 10 are angled so as to direct the light emitted from the back of the tubes toward the turntable 13. In a preferred embodiment, the mirrored surfaces 12 are angled to direct the maximum amount of light possible toward the turntable 13 and also positioned to enhance diffusion. In a preferred embodiment of the present invention, a commercially available curing chamber such as the ELC 500 manufactured by Electrolite Corporation having large flat interior surfaces and a small single mold turntable is used. It is anticipated by the present invention that other mirror configurations would enhance homogeneity of the light field such as small surfaces at small angles to each other, such as rectangular, circular or hexagonal panels placed in a substantially circular equidistant patter from the turntable.

In a second preferred embodiment, it is anticipated that the vectorless light field created in the curing chamber 10 would be enhanced by the use of a grid shaped light source.

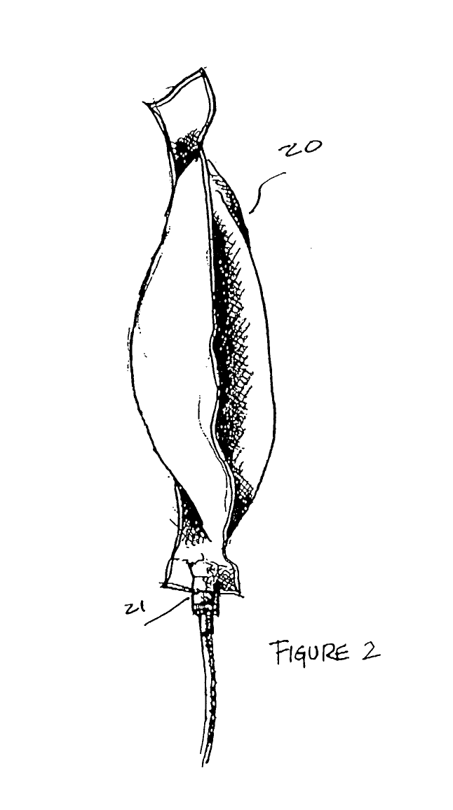

Referring now to FIG. 2, a perspective drawing of a flexible bag containing a resin formulation is shown generally at 20. These types of bags are well known in the art and are generally constructed from a flexible plastic material that is chosen as to have no chemical interaction with the contents of the bag. In a preferred embodiment of the present invention, the resin used in the molds is curable by exposure to UV-light and or visible light. The bag 20 therefore is preferably constructed of a light impenetrable flexible plastic to prevent premature curing of the resin. The bag 20 incorporates a self-sealing penetration 21, such as are well known in the art. It is desirable to place the penetration 21 on the bag 20 in a location so that all of the resin may be extracted from the bag 20 when the bag 20 is compressed. In a preferred embodiment, the penetration 21 is placed on a lower portion of the bag 20.

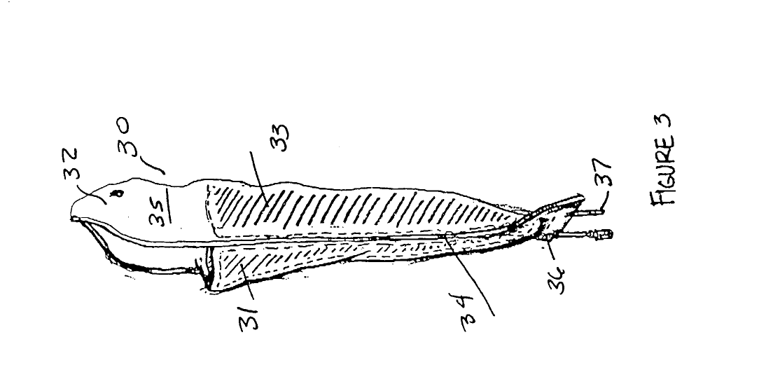

Referring now to FIG. 3, an inflatable envelope is shown generally at 30. The envelope 30 comprises a front panel 31, a back panel 32, and an internal bladder 33. The front panel 31, the back panel 32 and the bladder 33 are layered so the bladder is captured between the front panel 31 and the back panel 32. The front panel 31, the back panel 32 and the bladder 33 are joined together along a common sealed seam 34. In a preferred embodiment, the front and/or back panels 31 and 32 extend beyond the seam 34 at an upper portion of the envelope, providing an upper section 35 that may be pierced thereby allowing the envelope 30 to be secured to a hanger. The front panel 31 is provided with an opening 36 at a lower portion of the envelope 30 that allows the penetration 21 to extend from the envelope 30. The bladder 33 includes an extending penetration 37 that extends through the back panel 32, allowing the bladder 33 to be inflated. In a preferred embodiment, the bladder 33 is inflated using a blood pressure cuff hand operated air pump, or through the use of compressed gas or liquid as are commonly known in the art. Other means of inflating the bladder 33 may be used without affecting the novelty of the invention. In the preferred embodiment of the present invention, the envelope 30 is constructed of flat rectangular panels. The preferred material for the panels is rubberized woven nylon. It is anticipated that other materials of suitable durability and strength may be used to construct the envelope 30. The envelope 30 may also be constructed such that the bladder 33 approximates a wedge shape with the thickest portion located at the top portion of the bladder 33 to enhance the flow of resin toward the penetration 21, which is preferably located at a lower portion of the bag 20.

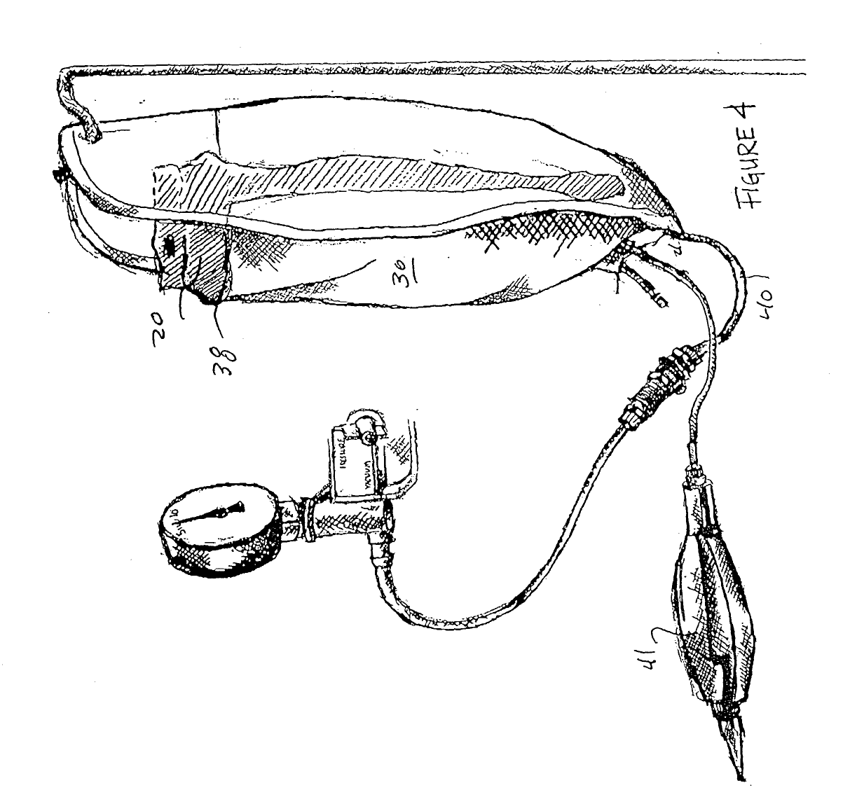

Referring now to FIG. 4, the envelope 30 may be seen with the bag 20 inserted. Also shown is a hose 40, connected to the penetration 21 and a dispensing wand 41. The envelope 30 is provided with an opening 38 allowing insertion of the bag 20.

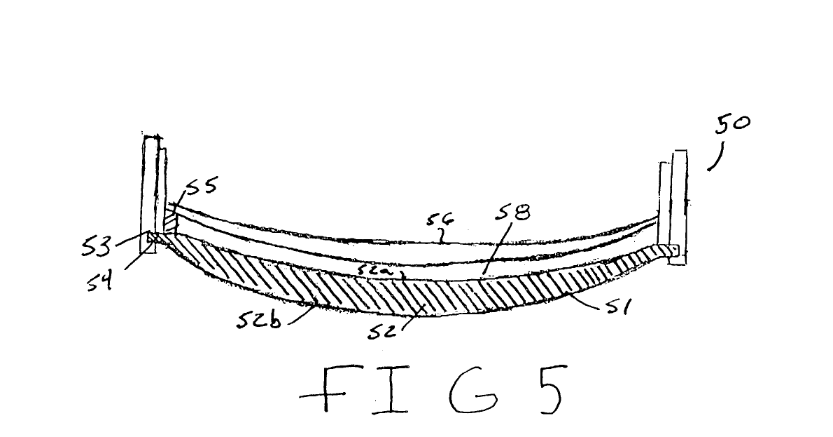

Referring now to FIG. 5 a lens mold assembly is shown generally at 50. The mold assembly 50 includes a front mold 51, having a plate 52, having an inner surface 52a, an outer surface 52b, and an annular dam 53, which is contiguous with the plate 52 along outer edge 54 of plate 52. Mold assembly 50 also comprises a back mold 56. Mold 51 comprises a series of lands 55 along outer edge 54 that extend in a generally perpendicular fashion from inner surface 52a. In a preferred embodiment, the lands 55 are integral with the front mold 50 and are not attached to the annular dam 53. The lands 55 support the back mold 56 and hold the front mold 51 in a spaced apart relationship to the back mold 56. The lands 55 may be of similar or different heights.

The back mold 56 has an outer diameter sized to form a friction fit along an interior surface of the annular dam 53. In a preferred embodiment, the annular dam 53 is permanently secured to the plate 52 and extends perpendicularly upward from edge 54, in the same direction as the lands 55. The annular dam 53 provides a structure in conjunction with the front mold 50, and the back mold 56 that defines a casting cavity 58. The annular dam thereby replaces the gaskets used in current art systems. In embodiments where the annular dam 53 is permanently secured to the plate 52, it is anticipated that the molds will be cleaned and reused. In a second preferred embodiment, the annular dam 53 is secured to the outer edge 54 by a thin section of material, allowing the annular dam 53 to be separated from the outer edge. In this second embodiment, it is anticipated that the mold 50 will be disposed of after a single use.

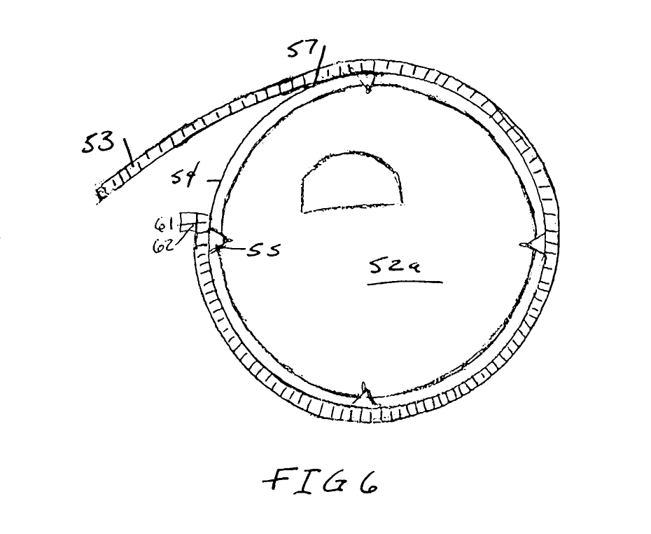

Referring now to FIG. 6, the annular dam 53 of the second embodiment may be seen. The annular dam 53 is secured to the outer edge 54 of mold 50 by a thin section of mold material 57, allowing the annular dam to be easily separated from the outer edge 54. In a preferred embodiment, mold 50 is manufactured using an injection molding process with a thermoset plastic material. It is anticipated that the annular dam 53, the lands 55 and the thin section 57 connecting the annular dam 53 to the outer edge 54 will be cast as a unit. In other embodiments, section 57 may be created by secondary operations.

In certain embodiments, the thermoset plastic material used to make the mold may be transparent to UV and visible light. In other embodiments, mold 50 may have a reflective coating to reflect the UV and visible light back into the resin to assist in curing. Other embodiments anticipate the use of polymer, thermoplastic or other materials that do not deform at elevated temperatures for use in heat based curing.

Referring to FIG. 6, a portion of the annular dam 53 may be seen. In a preferred embodiment, the annular dam 53 is secured to the outer edge 54 of mold 50 by a thin section of mold material 57, allowing the annular dam to be easily separated from the outer edge 54. To facilitate removal, the annular dam 53 in this embodiment comprises a tab 60. The annular dam 53 in generally continuous around the circumference of the mold 50. The tab 60 overlaps the ends of the annular dam 53 where they meet on the circumference, and provides a practitioner with a means to pull the annular dam, separating it from the mold 50. This type of structure is commonly found on plastic container bottles, and is well known in the art.

Referring again to FIG. 6, a filling port 61 may be seen. The port 61 is a small section of the annular dam 53 that is separated from the body of the annular dam 53 on three sides so that a flap 62 is formed. The port 61 allows the insertion of a device that can transfer resin into the casting cavity 58. In embodiments where the mold 50 is constructed of a thermoplastic polymer, the annular dam will be thin enough so the flap 62 is flexible, and the one side not separated from the body of the annular dam will act as a hinge. This design allows a device to be inserted into the casting cavity 58 by displacing the flap 62. The flap 62 will return to its original placement after removal of the filling device, and act to seal the port 61. It is envisioned that the flap 62 may be of larger dimension than the port 61, and be positioned to the interior of the casting cavity 58, thereby creating a seal preventing leakage of the resin from the casting cavity 58.

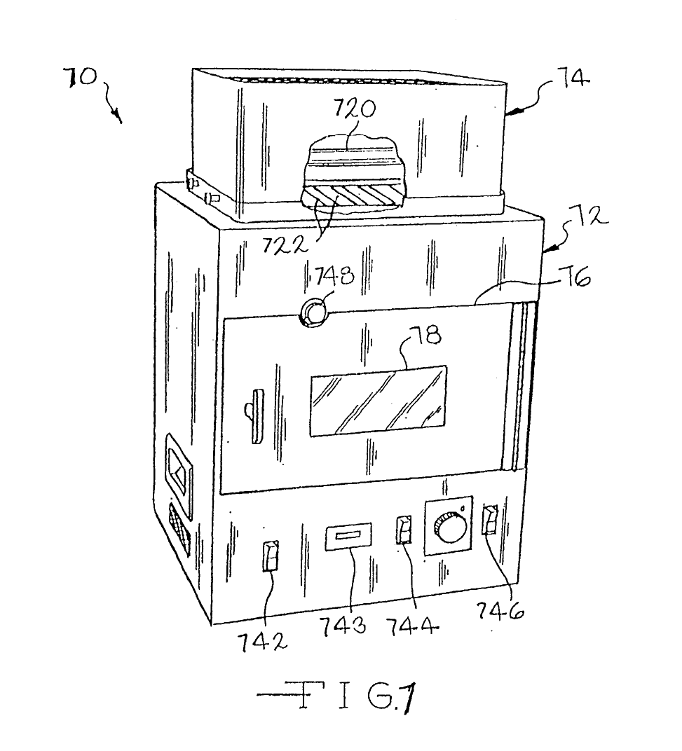

FIG. 7 generally shows an apparatus 70 of the present invention that includes a curing chamber 72 and a lamp housing 74. The curing chamber 72 has a door 76 which can have a viewing window 78. The lamp housing 74 contains a UV lamp 720 that produces light in both the visible light with a peak spectrum of 470 nm. In a preferred embodiment, the lamp housing 74 can have a plurality of shutters 722. However, it is also within the contemplated scope of the present invention that the lamp housing 74 can have a shutterless system using a rapid start ballast to produce ultraviolet and/or visible light exposure to the curing chamber.

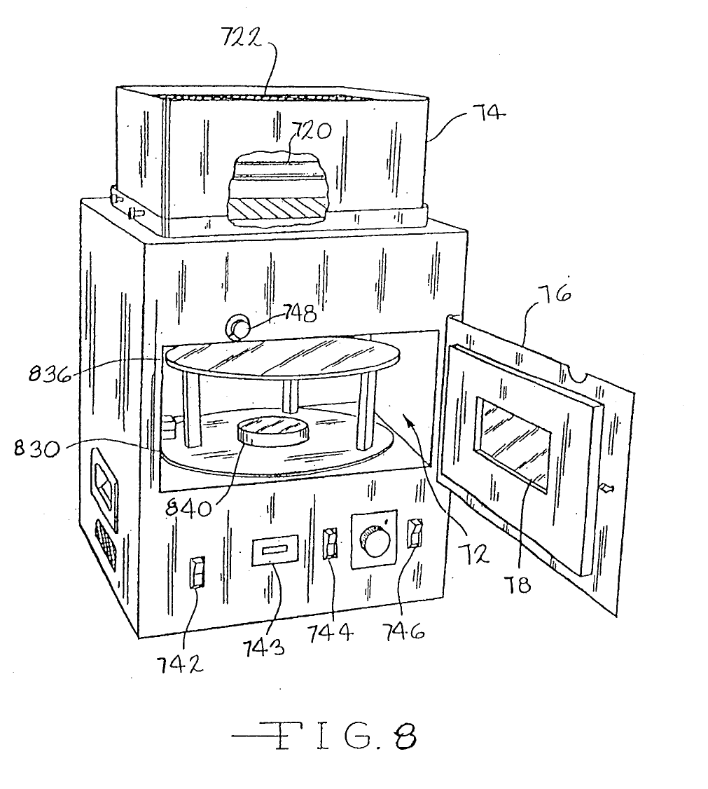

As shown in FIG. 8, the curing chamber 72 includes a carousel or rotating table 830 that is operatively connected to a motor (not shown) for turning the rotating table 830. In preferred embodiments, the turntable makes between 4-6 rpm. The curing chamber 72 further includes a diffusion member or plate 836 made of a frosted glass that is removable positioned on the table 830 when the curing chamber 72 is in use.

It is to be understood that the lamp 720 preferably generates ultraviolet light having wavelength in the range of about 300 nm to about 500 nm which is the preferred wavelength spectrum for curing polymer materials, as will be discussed below. The intensity of the ultra-violet light is diffused as the light passes through the diffusion plate 836. The diffusion of the light in the rotation of the lens being cured on the table 830 provides an overall uniform curing of the polymerizable material.

FIG. 8 shows a mold assembly 840 positioned on the rotating table 830. The rotating table 830 rotates the mold assembly 840 about an axis that extends into perpendicular direction to the plane of the lens being cast. In the operations of the lens making apparatus 70, an on-off power switch 742 is activated and an hour meter 743 is observed to determine whether certain adjustments are needed. A timer switch 744 is turned to an on position. A turntable switch 746 is moved to an on position. The shutters 722 are adjusted by moving the switch 748 from a closed to an open position. The UV light passes through the diffusion plate 836 and contacts the mold assembly 840, thereby allowing the rapidly curing polymerizable resin material to fully cure. The polymerizable material cures in a rapid time of less than about two minutes.

Those skilled in the art of lens making realized that lens forming materials take a long time to cure and have a tendency to shrink during cure. Accordingly, one aspect of the present invention is to provide an improved polymerizable material for lens making which does not have the drawbacks of the widely used CR 39 type polymers.

According to another aspect of the present invention, the polymerizable lens forming material comprises a mixture of at least one monomer resin in at least one photo-initiator. In preferred embodiments the monomer material can be a CR 424 monomer, which is made by PPG Industries, Optical Products Group, Pittsburgh, Pa. The CR 424 monomer properties are: 78% transmission through 15 mm; yellowness index of less than about 10, through about 50 mm; refractive index of 1.522, viscosity (centistokes at 25 degrees Centigrade) of 150 CPS; density (grams/cc at 25° C.) of 1.111; percent haze less than about one percent; storage stability (uninitiated at 20 to 25 degrees C. 68 to 77 degrees Fahrenheit) of at least five months. The polymer properties are a transmission of about 90.97%; yellowness index (11.8 mm thickness) 0.63; refractive index 1.554; Abbe No. 38; density (grams/cc at 25° C.) 1.205; Barcol hardness (0-15 seconds) 13-6; Bayer abrasion resistance (comparison to the CR 39 monomer) 0.75; polymerization shrinkage 8.20 percent; heat distortion temperature (° C. at 10 mil deflection) 51; and total heat deflection had 130° C. in mils (0.001 in.) 85. In another preferred embodiment, the monomer material known as CR 427, also made by the PPG Industries is useful to produce lenses that are harder and more scratch resistant than lens is made using the CR 424 monomer material. Other similar monomers may be used that have similar optical properties.

The monomer is preferably mixed with a suitable non-peroxide based photo-initiator that is reactive in visible light. The preferred mixture comprises a photo-initiator that cures uniformly throughout the polymerizable mixture, rather than a photo-initiator, which is a surface cure initiator only that migrates in the mixture. The photo-initiator preferably exhibits an ultraviolet absorption spectrum over 400 nm and also absorbs light in the visible spectrum. In preferred embodiments, the photo-initiator can comprise an Irgacure 819 material, which is produced by the CIBA Geigy Corp. The photo-initiator mixes readily with the optical monomer and is stable over a five to six-month period of time. It is to be understood that in certain embodiments, other photochemical initiators, including derivatives of acetophenone and benzophenone, including for example a Lucirin TPO diphenyl (2,4,6-trimethyl benzoyl), phosphine oxide material, which is a photo-initiator, made by the BASF Corp. can be used in the present invention.

The suitable monomer material has a very low shrinkage as compared to the CR 39 material that allows the lens being cast to be completely polymerizable and solidified with a period of about two minutes to five minutes. The rotation of the lens on the turntable in the diffusion of the UV light as the light passes through the diffusion plate provides a cast lens with no shadows or other distortions or crazing. The lenses produced according to the method of the present invention have a high uniformity and are stable and resistant to distress or fractures.

According to one preferred embodiment, the polymerizable lens forming material composition of the present invention includes about 80 to about 99.009% CR 424 or similar light or heat curable monomer material and about 0.001 to about. 2% photo-initiator. It is to be understood that various other optional ingredients can be included in the lens making composition that do not detract from the features of the lens polymer composition. These and other ingredients can be used by those skilled in the art of lens making.

In particular, the present invention anticipates the use of fluorinated compounds such as fluorinated Methacrylate that migrate to the surface of a monomer during curing. One such additive is 2,2,2-Triflouroethyl Methacrylate. Fluorinated compounds exhibit a migratory property such that when the lens is cured, the fluorinated compounds migrate toward the surface of the lens. The surface is then made harder than the underlying plastic and is therefore more scratch resistant. Another type of compound that may be successfully used and is anticipated by the present in invention is hydantion hexacrylate. This compound is migratory and exhibits cross-linking properties, also creating a harder outer surface on the manufactured lens.

According to another aspect of the present invention, photo chromatic lenses can be made using a mixture of the polymerizable lens forming material described herein and a photo chromatic dye, which is compatible with the UV curable resin material in the photo-initiator material. According to the present invention, a photo chromatic dye is mixed into the polymerizable lens forming material prior to any curing of the lens forming material. The method of the present invention produces many colors of photo chromatic lenses including red, green, blue, yellow, brown and gray. Useful photo chromatic dyes included Reversacols dyes manufactured by the James Robinson Limited Company and distributed in the United States by the Keystone Analine Corporation. The especially useful colors include Oxford Blue, Aqua Green, Sea Green, Berry Red, Flame Red, Rose Red, Plum Red, Palatinate Purple, Storm Purple, Rush Yellow and Corn Yellow.

The Reversacol type photo chromatic dyes include naphthopyran type dyes such as the Berry Red, Corn Yellow and Tangerine colors that have a chromene molecule type, while the Sea Green, Plum Red, Aqua Green, Oxford Blue, Claret, Palatinate Purple, and Storm Purple colors have a spirooxazine molecule type.

In certain embodiments, a photo chromatic yellow lens can be produced that is beneficial for patients requiring a blue light reduction and increased contrast. Patients with cataracts and patients participating in sports will benefit most from this tint.

A yellow lens can comprise a Reversacol Corn Yellow dye mixed in the polymerizable lens forming material in a concentration of about 0.5-0.2 grams per 1000 ml of lens forming material, depending on the degree of yellow required in the final activated lens.

A gray lens can comprise a mixture of Reversacol Berry Red, Sea Green, and Corn Yellow dyes in a concentration of about 0.1 to 0.2 grams per 1000 ml of activated monomer.

A brown lens can comprise the gray lens formulation with an increase in the Corn Yellow dye in the gray mixture.

A blue lens can comprise a mixture of Reversacol Palatinate Purple, Oxford Blue, and/or Storm Purple dyes in a concentration of about 0.01-0.2 grams of dye in 1000 ml of activated monomer. This lens is a cosmetic deep blue photo chromatic lens.

A red lens can comprise a mixture of Reversacol Berry Red and/or Plum Red to concentration of about 0.01-0.2 grams of dye in 1000 ml of activated monomer. This lens is a cosmetic deep Red photo chromatic lens.

A gray lens can comprise a mixture of Reversacol Aqua Green and/or Sea Green dyes in a concentration of about 0.01-0.2 grams of dye in 1000 ml of activated monomer. This lens is a cosmetic green photo chromatic lens.

This method of photo chromatic lens production allows the manufacturer to cast lenses directly to a patient's prescription, in a chosen color, while the patient waits, thus reducing lens inventory. Also, the photo chromatic lenses do not have to be pre-cast and sent to another manufacturer for photo chromatic dye addition. It is also within the contemplated scope of the present invention that multiple color photo chromatic lenses can be cast by filling the mold with layers of different colors of the photo chromatic dye lens forming material. It is further within the contemplated scope of the present invention that the photo chromatic dyes be added solely to a scratch resistant coating applied to the surface of lens. According to another aspect of the present invention, infrared dyes, such as those made by Exciton.Corp. May be added to the lens monomer to add Infrared protection in the final cast lens. One such dye is DNDTCO, which has a peak spectral absorption between 1084-1168 nm.

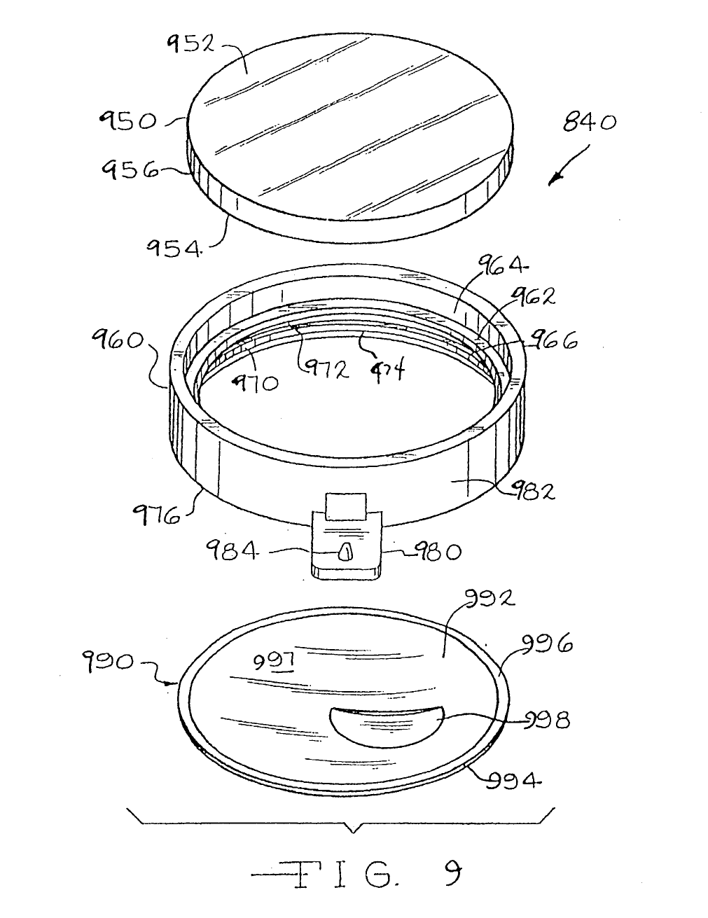

Referring now to FIG. 9, the mold assembly 840 is shown in exploded perspective view. The mold assembly 840 includes a back or top mold 950 preferably made of a glass material. The back mold 950 has an upper surface 952 and a lower surface 954. The back mold 950 has an edge 956 extending around the circumference of the back mold 950. The lower surface 954 of the back mold 950 has an optimum curvature, which provides at least part of the required correction for the lens to be molded.

The lens assembly 840 further comprises a gasket 960 made of a flexible or elastomeric plastic material that is compatible with the polymerizable resin material. In the preferred embodiments, the gasket is made of the material, which is ultraviolet and visible light transparent. Suitable flexible materials that do not react with the lens casting polymers include polyvinyl chloride, soft polymethyl methacrylate and polyethylene, among others. It is to be understood that various flexible plastic materials that allow the transparency of ultraviolet and visible light can be used with the present invention.

The gasket 960 defines an upper inner edge or lip 962 which extends in a radially inward direction circumferentially around in inner surface 964 of the gasket 960. The upper edge 962 has an annularly extending face or circumferential surface 966. The surface 966 has a desired predetermined height or depth of equal thickness the circumference of the gasket. It is to be understood that various gaskets can have different heights of the surface 966 so that different thicknesses of lens can be cast. It is to be further understood a polymer based disposable insert the has varying thickness to match the contour of the finished lens may be inserted against the annular face. Thus reducing the number of gaskets necessary to make the full range of potential prescriptions the system can cast.

The gasket 960 defines a lower edge or lip 970 that extends in a radially inward direction around in inner surface 964 of the gasket 960. The lower edge 970 has an upper surface 972 that are in a spaced apart relationship to the upper edge 966, and lower surface 974 that is in a spaced apart relationship to a bottom portion 976 of the gasket 960.

In various embodiments, the gasket 960 also has a tab 980 integrally molded with an outer surface 982 of the gasket 960. The tab 980 has a retaining plug or member 984 which secures the tab to dispensing stand 101 when a polymerizable lens forming material 130 (either with or without at least one photo chromatic dye) is being injected between the back mold member 950 and a front mold member 990, as will be explained in detail below.

The lens assembly 840 further comprises a front or bottom mold 990 that is preferably made of a metal material. The front mold 990 has an upper or inner surface 992 and a lower surface 994. The front mold 990 has a flat beveled rim or edge 996. In a preferred embodiment the front mold 990 is made of a nickel material that is coated this harder metal like chromium or rhodium, or electrocoated with a diamond like carbon coating 997. In certain preferred embodiments, when bifocal lenses are to be cast, the front mold 990 can have a bifocal segment 998 on the inner surface 992.

When assembled in the gasket 960, the front mold member 990 and the back mold 950 define a cavity 978 that receives the polymerizable resin material 130. It is understood by those skilled in the art that dimensions of the cavity 978 determine the shape of lens to be cast.

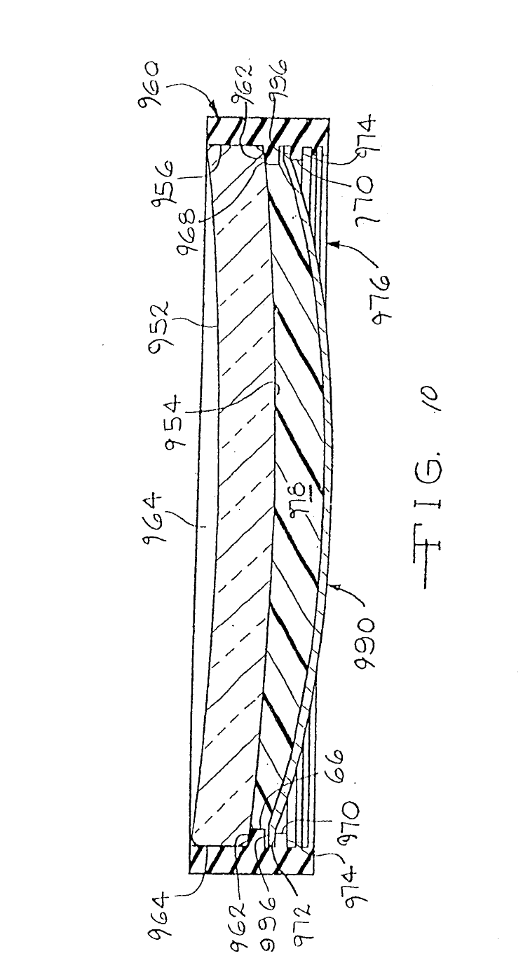

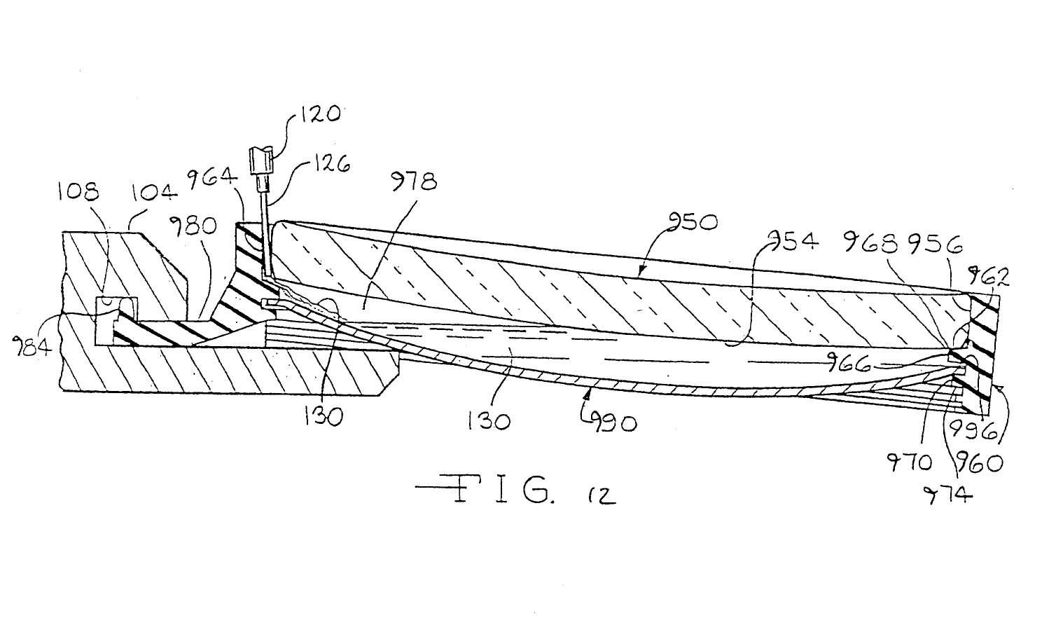

Referring now to FIGS. 10 and 12, the mold assembly 840 is shown ready to accept the resin material 130. The front mold 990 is positioned in the gasket 960. The bevel edge 996 of the front mold 990 is engaged in the space between the upper edge 962 and the lower edge 970. The lower edge 970 holds the front mold 990 in a secure position in the gasket 960.

The back mold 950 is placed in the gasket 960. The lower surface 954 of the top mold 950 is adjacent an upper surface 968 of the upper edge 962. The circumferential surface 956 of the back mold 950 is secured against the inner surface 964 of the gasket 960.

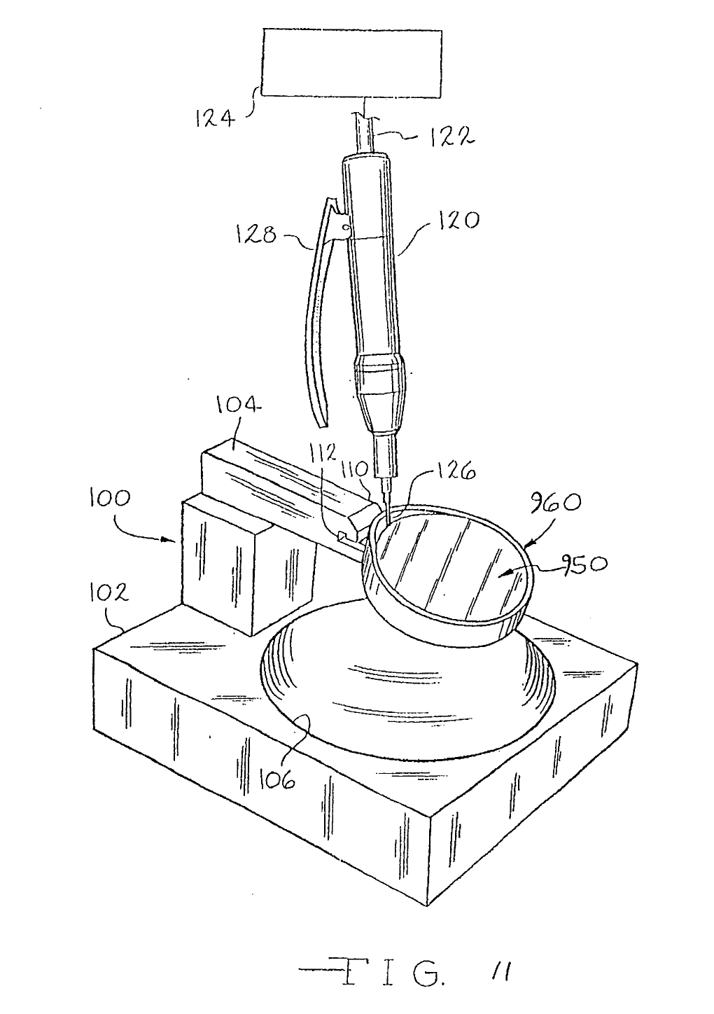

Referring now to FIG. 11, the dispensing stand 100 is generally shown. The dispensing stand 100 has a base 102 and support arm 104 in a spaced apart relationship to the base 102. In a preferred embodiment the base 102 of the dispensing stand 100 defines a well 106 for receiving any excess resin material. The supporting arm 104 has a first or distal end 110 in a spaced apart relationship to the base 102. The distal end 110 defines an opening 112 for slideably receiving the tab 980 of the gasket 960.

The dispensing pen 120 is used to dispense a predetermined amount of the polymerizable resin material 130 into the mold assembly 840. The dispensing pen 120 is attached by a tube 122 to a pressurized container 124 in a manner that is well known in the art. In alternative embodiments, the pressurized container is replaced by a flexible bag system as described above. The dispensing pen 120 has a tip 126 that allows the polymerizable resin material 130 to be accurately dispensed. In the embodiment shown, a handle 128 is retracted or squeezed by the user to dispense a predetermined amount of the polymerizable resin material 130. As shown in FIG. 12, the gasket 960 is stretched or flexed and the tip 126 is placed adjacent the sidewall 964 of the gasket 960 in a manner such that the polymerizable resin material 130 flows into the cavity 978 defined between the front mold 960 and the back mold 950. The front mold 990 is held securely in position by the gasket 960 by the lower edge 970 of the gasket 960. The polymerizable resin material 130 flows to the circumferential surface 966 of the upper lip or edge 962 such that the polymerizable resin material 130 substantially completely fills the cavity 978.

After the polymerizable resin material 130 substantially fills the cavity 978, the mold assembly 840 is slideably removed from the opening 112 in the stand 100. It is to be understood that in certain embodiments the dispensing stand is not needed. The dispensing tip 126 can be inserted between the circumferential edge 964 of the gasket 960 in the circumferential edge 956 of the back mold 950 simply by flexing one edge of the gasket 960 in a direction away from back mold 950.

After the mold assembly 840 is filled with the polymerizable resin material 130, the mold assembly 840 is placed in the curing chamber 712 and cured in a manner as described above.

After the polymerizable resin material 130 is cured, the user removes the gasket 960 and applies pressured to release the portion of the edge of the cast lens, which allows the lens to be released from the front mold 990 and the back mold 950.

In other embodiments, it is possible to use the pre-cast front or end plate to make polycarbonate lenses or to make lenses with photo chromatic, anti-reflective, or anti-reflective photo chromatic features. In such embodiments, the front mold 990 would be replaced with a front mold incorporating a microstructure into its surface. In applications were a hard surface would not be necessary, such as in the casting of interocular lenses, the polymerizable resin material 130 would be used directly against the front mold 950 comprising the microstructure. And other embodiments, where a hardened surface would be desired, such as in eyeglass lenses, a chemical solution such as “hard-coat”, “sol-gel”, or “hydrophobic” would be applied to the inner surface 954 of the front mold 950. The chemical solution would then become bonded directly to the polymerizable resin during the curing process. It is to be further understood that front mold can be formed such that bifocal or progressive lenses can also be cast by using the method and apparatus of the present invention.

Another aspect of the present invention relates to coating a substrate with a photo chromatic material to produce an article that changes color when exposed to different wavelengths of light. It is within a contemplative scope of the present invention that the photo chromatic dye compositions discussed herein are useful in preparing a photo chromatic coating composition. According to a preferred method, the photo chromatic dyes are mixed with a suitable medium and coated on to the substrate. In alternative methods contemplated herein, the photo chromatic dyes may be mixed with the “hard-coat”, “sol-gel.” or “hydrophobic” In this second embodiment, a tinted or photo chromatic lens may be produced using a minimum of dye.

In one embodiment, the photo chromatic dyes are mixed with a suitable medium and coated on to at least one surface of an optical lens material, such as the optical lens is described above. However, it is also within the contemplative scope of the present invention that other types of optical lenses can be coated with the photo chromatic composition to produce lenses that change color. Including intraocular lenses.

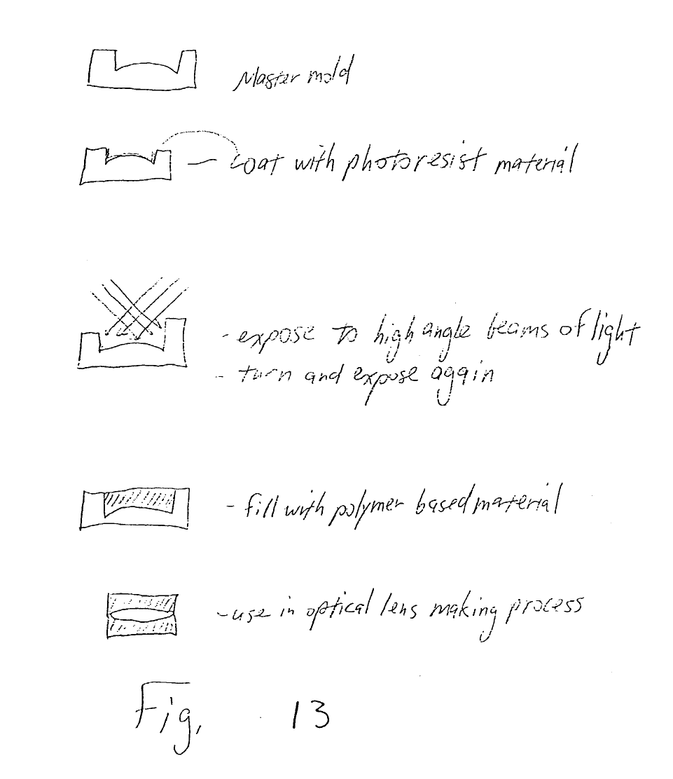

FIG. 13 is a schematic diagram showing a method for making polymer-based molds. A master mold is formed of a suitable material. The master mold is coated with a photo-resist material, which is shown in an exaggerated manner for ease of illustration. Thereafter, the photo-resist coated surface is exposed to high angled beams of light that impact the surface at preferred angles. Preferably, the photo-resist coated material is exposed to at least two sets of beams of light that intersect and high angles which then form an interference pattern on the photo-resist surface. For certain embodiments, the photo-resist surface is exposed to a second exposure of light and angles that differ from the first exposure of light. This can be accomplished for example, by turning the master mold a preferred amount, for example rotating it 90 degrees. A second interference pattern is then formed on the photo-resist coated surface. The photo-resist surface thus has a microstructure pattern etched or embedded on the interior surface of the master mold, after developing.

One particular type of microstructure produced a “moth eye” type of surface. Moth-eye surfaces or structures are also known as zero order gratings that provide anti-reflective surfaces for polarization control or for light beam splitting and also for color control. These structures are found in nature and provide useful anti-reflective features in the cornea of some types of insects. These anti-reflective services also provide color to some types of insects such as butterflies or have selective reflection features in the leaves of some plants.

The microstructure surface master mold is then filled with a suitable polymer based material the form optical mold. The polymer-based mold is then used in optical lens making processes.

Having described the invention above, various changes from the specific materials, procedures and apparatus will occur to those skilled in the art. It is intended that all such variations be within the scope and spirit of the appended claims.

What is claimed:

1. A polymer based mold for casting optical lenses, the molding comprising the first surface in a second surface in having a plurality of microstructures formed on at least one of the first and/or second surfaces.

2. The mold of claim 1, wherein the microstructures form a pattern for allowing in anti-reflective lens to be cast with said mold.

3. A method for forming a polymer based mold for casting optical lenses comprising producing a pattern of angled surfaces onto a first side of the mold insert.

4. The lens formed using the polymer based mold of claim 1.

5. A method for forming the polymer based mold insert of claim 3, comprising:
forming a master mold;
applying a coating of a suitable photo-resist material to an interior surface of the master mold;
exposing the photo-resist coated surface of the master mold to a source of light which impact the surface at preferred angles to form an anti-reflective surface; and
Filling the interior of the master mold with a suitable polymer based material and curing to form the polymer based mold.

6. The method of claim 5, in which the photo-resist coated material is exposed to a first exposure of at least two beams of light that intersect and high angles, thus forming a first interference pattern on the photo-resist coated surface.

7. The method of claim 6 in which the photo-resist coated surface is exposed to a second exposure of light and angles that differ from the first exposure of light, thus forming a second interference pattern on the photo-resist coated surface.

8. The method of claim 5 in which the photo-resist coated material is exposed to a first exposure of at least three beams of light that intersect and high angles, thus forming a first interference pattern on the photo-resist coated surface.

9. The method of claim 8 in which the photo-resist coated material is exposed to a second exposure of light at angles that differ from the first exposure of light, thus forming a second interference pattern on the photo-resist coated surface.

10. The polymer based mold of claim 2, wherein the microstructures produce a “moth eye” type of surface.

11. The polymer based mold of claim 2, wherein said molds are transparent ultraviolet and visible light.

12. The polymer based mold of claim 2, wherein said molds are reflective ultraviolet and visible light.

13. The polymer based mold of claim 2, wherein said molds are opaque to ultraviolet and visible light.

14. The lens formed using the polymer based mold of claim 11.

15. The lens formed using the polymer based mold of claim 12.

16. The lens formed using the polymer based mold of claim 13.

17. A method for forming a lens with an anti-reflective surface comprising the steps of:
applying a suitable chemical formulation that forms a hard surface upon curing to an interior surface of a lens mold having a microstructured surface;
creating a lens mold cavity using a front mold, a back mold and a gasket;
filling said cavity with a suitable polymerizable monomer; and
curing said monomer.

18. The lens produced using the method of claim 17.

19. A gasket-less lens molding system comprising:
a front mold comprising an annular dam extending inwardly perpendicularly from an exterior edge,
a plurality of lands preferentially placed on an interior surface of said annular dam, extending inwardly perpendicularly from said front mold, adjacent to said dam, and a back mold.

20. The device as recited in claim 19 wherein said lands support said back mold in a spaced apart relationship to said front mold, said annular dam forming a seal around a circumferential edge of said back mold, said back mold, said front mold and said annular dam forming a molding cavity.

21. The device as recited in claim 20 wherein said lands are of differing heights.

22. The device as recited in claim 20 wherein said front mold is formed to produce bifocal lenses.

23. The device as recited in claim 20 wherein said front mold is formed to produce progressive lenses.

24. The device as recited in claim 20 wherein said annular dam is releasably secured to said exterior edge.

25. The device as recited in claim 20 wherein said lands are integrally formed with said front mold.

26. The device as recited in claim 20 wherein said lands are integrally formed with said annular dam.

27. The device as recited in claim 19 wherein said front mold comprises a micro-structured surface.

28. A gasket-less lens forming method comprising the steps of:
creating a lens mold cavity using the device as recited in claim 19;
filling said cavity with a suitable polymerizable monomer; and
curing said monomer.

29. A gasket-less method for forming a lens with an anti-reflective surface comprising the steps of:
creating a lens mold cavity using the device as recited in claim 27,
applying a suitable chemical formulation that forms a hard surface upon
curing to an interior surface of said front mold;
creating a lens mold cavity using the device as recited in claim 27;
filling said cavity with a suitable polymerizable monomer; and curing said monomer.

30. A reduced number of gasket system using gaskets with an annular ring of varying continuous thicknesses.

31 A disposable insert that can be placed into claim 30 that has varying thickness to induce prism and or to match the varying thickness of the back transparent mold.

32. An improved curing chamber comprising:
an interior chamber appropriately sized to receive a lens mold assembly,
a horizontal turntable located at the geometric center of said chamber sized to support said assembly,
a plurality of UV and or Visible light sources preferentially placed inside said chamber such that the intensity of light impinging upon said turntable is uniform and directionally vectorless.

33. The device as recited in claim 32 wherein said chamber comprises interior surfaces that are reflective of light.

34. The device as recited in claim 32 wherein said reflective surfaces are angled to focus reflected light upon said turntable.

35. The device as recited in claim 32 wherein said plurality of light sources is replaced by a single light source in the shape of a grid.

36. The device as recited in claim 32 wherein a diffusion plate is introduced between said light source and said turntable.

37. The device as recited in claim 32 may have a visible and UV source that is regulated by a controller that cures the lens body first with visible light and then hardens the surface with UV light.

38. A monomer resin dispensing system comprising:
an inflatable envelope,
a flexible, opaque plastic bag containing a discrete amount of premixed monomer resin, said bag having a self sealing penetration incorporated into it, and
a delivery tube having a first end attached to said penetration and a second end attached to a delivery wand.

39. The device of claim 38 wherein said inflatable envelope comprises:
a rectangular top panel and a rectangular bottom panel of similar dimension, said top panel and said bottom panel secured along three of their respective edges to form an envelope with an open end,
said bottom panel comprising a first panel and a second panel secured along their respective edges capturing an inflatable bladder there between.

40. A method for manufacturing plastic lenses comprising the steps of:
providing a discrete amount of pre-packaged monomer in an opaque flexible plastic bag,
placing said bag in an inflatable envelope,
inflating said envelope and dispensing said monomer into a lens forming mold, and
curing said mold.

41. A polymerizable resin material comprising: (i) a photo initiator comprising a mixture of bis (2, 6-dimethoxybenzoyl)-2,4,4-trimethylpentyl phosphine oxide and 2-hydroxy-2-methyl-1phenyl-propan-1-one, (ii) a polymer material which, when exposed to visible light for a period of ten minutes or less, cures without need for the addition of heat or the polymerizable resin material, and (iii) a fluorinated methacrylate.

42. The compound as described in claim 41 wherein said fluorinated methacrylate is 2,2,2-trifluoroethyl methacrylate.

43. A polymerizable resin material comprising: (i) a photo initiator comprising a mixture of bis (2, 6-dimethoxybenzoyl)-2,4,4-trimethylpentyl phosphine oxide and 2-hydroxy-2-methyl-1phenyl-propan-1-one, (ii) a polymer material which, when exposed to UV light for a period of two and a half minutes or less, cures without need for the addition of heat or the polymerizable resin material, and (iii) a hydantion hexacrylate.
